(19) United States
(12) Patent Application Publication
(10) Pub. No.: US 2016/0277242 A1
(43) Pub. Date: Sep. 22, 2016

(54) CONDUCTING ONLINE MEETINGS USING USER BEHAVIOR MODELS BASED ON PREDICTIVE ANALYTICS

(71) Applicant: Citrix Systems, Inc., Fort Lauderdale, FL (US)

(72) Inventor: Ahmed Said Sallam, Cupertino, CA (US)

(21) Appl. No.: 14/661,056

(22) Filed: Mar. 18, 2015

(51) Int. Cl. H04L 12/24; H04L 29/08; H04L 29/06

(52) U.S. Cl. CPC H04L 41/0816; H04L 65/403; H04L 67/18; H04L 41/0846

(57) ABSTRACT

A computer-implemented technique conducts an online meeting. The technique involves collecting, by processing circuitry, configuration data for a plurality of user I/O devices available to a particular user. The technique further involves generating, by the processing circuitry, a user behavior model for the particular user based on the configuration data. The user behavior model includes, for each user I/O device of the plurality of user I/O devices, a set of device settings to customize operation of that user I/O device for the particular user. The technique further involves customizing, by the processing circuitry, the plurality of user I/O devices based on the user behavior model to communicate user I/O between the particular user and other users during a current online meeting.

### BACKGROUND

A typical web meeting shares visual content and audio content among multiple web meeting members. In particular, each web meeting member connects a respective computerized device to a central web meeting server over a computer network. Once the computerized devices of the web meeting members are connected with the central web meeting server, the members are able to watch visual content, as well as ask questions and inject comments to form a collaborative exchange even though the web meeting members may be scattered among remote locations.

Along these lines, a web meeting member can join a smart phone to a web meeting and thus use the various smart phone features during the web meeting (e.g., the camera, the touch screen, the microphone, the audio jack, etc.). Alternatively, the web meeting member can put down the smart phone, and manually join a desk top computer to the web meeting and thus use the various features of the desktop computer during the web meeting (e.g., a webcam, a computer monitor, an external microphone, an external speaker, etc.).

### SUMMARY

Advantageously, improved techniques involve conducting online meetings utilizing user behavior models which automatically direct usage of particular user input/output (I/O) devices during the online meetings. In particular, as users engage in initial online meetings with colleagues, peers, friends, etc., online meeting circuitry collects histories of which user I/O devices are available and used by each user. Predictive analytics is then applied to derive user behavior models which control activation and configuration of those user I/O devices during future online meetings. Accordingly, the users are less burdened with manual details of selecting and configuring user I/O devices for online meetings over time.

In an example use case, once a user behavior model has been generated for a particular user based on past online meetings of that user, control circuitry probes (i) a calendar or schedule utility of the user to determine future online meetings and (ii) global satellite positioning (GPS) circuitry of the user's smart phone to determine his/her location. To begin the user's participation in a scheduled online meeting, the control circuitry automatically identifies the user's current location via the user's smart phone and then joins the user to the scheduled online meeting. If the control circuitry determines that the user's desktop computer equipment (or other preferred user I/O devices) are available to the user based on the user's current location, the control circuitry joins the user to the scheduled online meeting using that preferred equipment. However, if the control circuitry determines that such preferred equipment is not available to the user based on the user's current location, the appropriate circuitry joins the user to the scheduled online meeting simply using the user's smart phone. Accordingly, user participation in online meetings is made easier, simpler and faster.

One embodiment is directed to a computer-implemented method of conducting an online meeting. The method includes collecting, by processing circuitry, configuration data for a plurality of user I/O devices available to a particular user. The method further includes generating, by the processing circuitry, a user behavior model for the particular user based on the configuration data. The user behavior model includes, for each user I/O device of the plurality of user I/O devices, a set of device settings to customize operation of that user I/O device for the particular user. The method further includes customizing, by the processing circuitry, the plurality of user I/O devices based on the user behavior model to communicate user I/O between the particular user and other users during a current online meeting.

In some arrangements, collecting the configuration data for the plurality of user I/O devices includes gathering device parameters from the plurality of user I/O devices. In these arrangements, the device parameters identify individual capabilities of each user

I/O device of the plurality of user I/O devices (e.g., resolution, display size, video/audio quality, etc.).

In some arrangements, collecting the configuration data for the plurality of user I/O devices includes obtaining initial settings from the plurality of user I/O devices. In these arrangements, the initial settings customize operation of the plurality of user I/O devices during an initial online meeting of the particular user which occurs prior to the current online meeting (e.g., camera direction, volume level, brightness, etc.).

In some arrangements, collecting the configuration data for the plurality of user I/O devices includes acquiring pre-populated default settings for the plurality of user I/O devices. In these arrangements, the pre-populated default settings define default operation of the plurality of user I/O devices during a default online meeting (e.g., labels identifying meeting rooms, buildings, offices, etc.).

It should be appreciated that such device parameters, initial settings, pre-populated default settings, and so on, form part of the configuration data. According, generating the user behavior model can include deriving, for each user I/O device of the plurality of user I/O devices, device settings (e.g., access control heuristics) to customize operation of that user I/O device based on analytics performed on the configuration data.

In some arrangements, customizing the plurality of user I/O devices based on the user behavior model includes:
(A) receiving a location signal from the particular user, the location signal identifying a current location of the particular user,
(B) generating a list of appropriate user I/O devices based on the user behavior model and the current location of the particular user identified by the location signal, the list of appropriate user I/O devices identifying less than all of the plurality of user I/O devices, and
(C) activating only the appropriate user I/O devices on the list of appropriate user I/O devices to include only the appropriate user I/O devices and less than all of the plurality of user I/O devices in the current online meeting.
   A variety of circuitry is suitable for providing the location signal such as a global satellite positioning circuit in the user's smart phone, an IP address which is mapped to a particular room, floor, building, and so on.

In some arrangements, activating only the appropriate I/O user devices includes replacing at least some default settings of the appropriate user I/O devices with the derived device settings to customize operation of the appropriate user I/O devices. Examples include volume settings for a particular microphone, direction settings for a particular camera, volume settings for a particular speaker, and brightness settings for a particular display.

In some arrangements, at least two of the particular microphone, the particular camera, the particular speaker and the particular display reside on a single user apparatus.

In some arrangements, one of the particular microphone, the particular camera, the particular speaker and the particular display resides on first user apparatus. In these arrangements, another of the particular microphone, the particular camera, the particular speaker and the particular display resides on second user apparatus which is different than the first user apparatus, the second user apparatus (e.g., a desktop computer apparatus) operating independently of the first user apparatus (e.g., a smart phone apparatus).

In some arrangements, the plurality of user I/O devices includes multiple microphones. Here, the configuration data defines a numerical sound quality measurement and a location for each microphone of the multiple microphones. Additionally, the user behavior model includes a microphone database which identifies preferred microphones for different locations based on the numerical sound quality measurement and the location for each microphone defined by the configuration data. Furthermore, activating only the appropriate I/O user devices includes, in response to accessing the microphone database of the user behavior model, activating exactly one of the preferred microphones during the current online meeting.

In some arrangements, the plurality of user I/O devices includes multiple cameras. Here, the configuration data defines a resolution and a location for each camera of the multiple cameras. Additionally, the user behavior model includes a camera database which identifies preferred cameras for different locations based on the resolution and the location for each camera defined by the configuration data. Furthermore, activating only the appropriate I/O user devices includes, in response to accessing the camera database of the user behavior model, activating exactly one of the preferred cameras during the current online meeting. In some arrangements, the plurality of user I/O devices includes multiple speakers.

Here, the configuration data defines a resolution and a location for each speaker of the multiple speakers. Additionally, the user behavior model includes a speaker database which identifies preferred speakers for different locations based on the resolution and the location for each speaker defined by the configuration data. Furthermore, activating only the appropriate I/O user devices includes, in response to accessing the speaker database of the user behavior model, activating exactly one of the preferred speakers during the current online meeting.

In some arrangements, the plurality of user I/O devices includes multiple displays. Here, the configuration data defines a numerical display quality measurement and a location for each display of the multiple displays. Additionally, the user behavior model includes a display database which identifies preferred displays for different locations based on the numerical display quality measurement and the location for each display defined by the configuration data. Furthermore, activating only the appropriate I/O user devices includes, in response to accessing the display database of the user behavior model, activating exactly one of the preferred displays during the current online meeting.

In some arrangements, the method further includes generating, by the processing circuitry, other user behavior models for the other users. In these arrangements, the method further includes customizing the plurality of user I/O devices based on the other user behavior model to communicate user I/O among all of the users during the current online meeting.

In some arrangements, the method further includes acquiring new configuration data from the plurality of user I/O devices during the current online meeting. In these arrangements, the method further includes updating the user behavior model for the particular user and the other user behavior models for the other users based on the new configuration data acquired from the plurality of user I/O devices during the current online meeting.

Another embodiment is directed to online meeting server equipment which includes a communications interface, memory, and control circuitry coupled to the communications interface and the memory. The memory stores instructions which, when carried out by the control circuitry, cause the control circuitry to:
(A) collect, through the communications interface, configuration data for a plurality of user I/O devices available to a particular user,
(B) generate a user behavior model for the particular user based on the configuration data, the user behavior model including, for each user I/O device of the plurality of user I/O devices, a set of device settings to customize operation of that user I/O device for the particular user, and
(C) customize, through the communications interface, the plurality of user I/O devices based on the user behavior model to communicate user I/O between the particular user and other users during a current online meeting.

Yet another embodiment is directed to a computer program product having a non-transitory computer readable medium which stores a set of instructions to conduct an online meeting. The set of instructions, when carried out by computerized circuitry, causes the computerized circuitry to perform a method of:
(A) collecting configuration data for a plurality of user input/output (I/O) devices available to a particular user;
(B) generating a user behavior model for the particular user based on the configuration data, the user behavior model including, for each user I/O device of the plurality of user I/O devices, a set of device settings to customize operation of that user I/O device for the particular user; and
(C) customizing the plurality of user I/O devices based on the user behavior model to communicate user I/O between the particular user and other users during a current online meeting.

It should be understood that, in the cloud context, certain circuitry is formed by remote computer resources distributed over a network. Such a computerized environment is capable of providing certain advantages such as distribution of hosted services and resources (e.g., software as a service, platform as a service, infrastructure as a service, etc.), enhanced scalability, etc.

Other embodiments are directed to electronic systems and apparatus, processing circuits, computer program products, and so on. Some embodiments are directed to various methods, electronic components and circuitry which are involved in conducting online meetings using user behavior models.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram of an electronic setting which is suitable for conducting online meetings using user behavior models based on predictive analytics.

FIG. 2 is a block diagram of an example layout which includes multiple user input/output (I/O) devices available for use by a user during an online meeting.

FIG. 3 is a block diagram of online meeting server equipment of the electronic setting of FIG. 1.

FIG. 4 is a block diagram of example configuration data which is supplied by a user I/O device to the online meeting server equipment.

FIG. 5 is a block diagram of example pre-populated data which is supplied by an administrator to the online meeting server equipment.

FIG. 6 is a block diagram of an example set of user behavior models which are generated and utilized by the online meeting server equipment to conduct online meetings.

FIG. 7 is a flowchart of a procedure which is performed by the online meeting server equipment.

### DETAILED DESCRIPTION

An improved technique involves conducting an online meeting utilizing a user behavior model which automatically directs usage of particular user input/output (I/O) devices over other available user I/O devices during the online meeting. In particular, as a user engages in initial online meetings with colleagues, peers, friends, etc., online meeting circuitry collects histories of which user I/O devices are available and used by that user. Predictive analytics is then applied to derive a user behavior model which controls activation and configuration of those user I/O devices during future online meetings. Accordingly, the user is less burdened with manual details of selecting and configuring user I/O devices for online meetings over time.

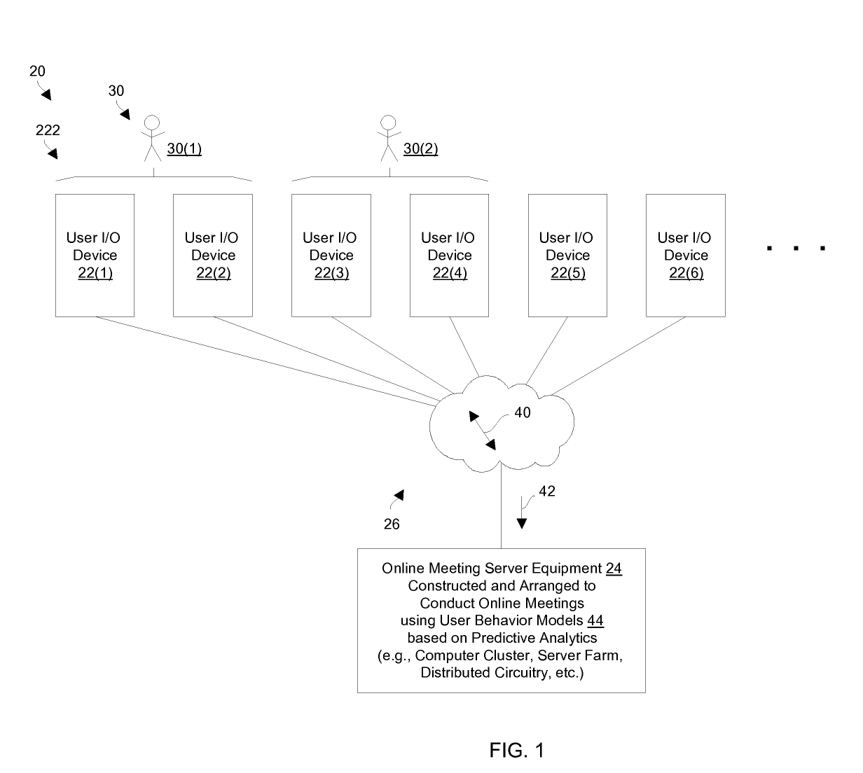

FIG. 1 shows a computerized setting 20 which is suitable for conducting online meetings using user behavior models based on predictive analytics. The computerized setting 20 includes multiple user I/O devices 22, online meeting server equipment 24, and a communications medium 26.

Each user I/O device 22 is constructed and arranged to perform useful work on behalf of one or more users 30. To this end, each user I/O device 22 is a smart device which is provisioned with specialized code to operate in tandem with the online meeting server equipment 24 during online meetings. In some arrangements, the specialized code is part of an installed online meeting client application. In other arrangements, the specialized code is independent of the online meeting client application thus enabling use on legacy devices 22 which run conventional online meeting client applications.

It should be understood that some of the user I/O devices 22 are controlled exclusively by specific users 30 while other user I/O devices 22 are publicly available apparatus. Along these lines, the user I/O device 22(1) may be a smart phone and the user I/O device 22(2) may be a desktop computer of the same user 30(1). Similarly, the user I/O device 22(3) may be a smart phone and the user I/O device 22(4) may be a tablet of the same user 30(2). Furthermore, the user I/O device 22(5) may be a guest workstation which is normally accessed by multiple users 30 at different times, the user I/O device 22(6) may be a smart television statically installed in a conference room of an office building, and so on.

The online meeting server equipment 24 is constructed and arranged to reliably and robustly host online meetings among the users 30 using the user I/O devices 22. In some arrangements, the online meeting server equipment 24 is formed by multiple computers organized in a cluster. In other arrangements, the online meeting server equipment 24 is formed by a server farm. In yet other arrangements, the online meeting server equipment 24 is formed by distributed circuitry, i.e., the online meeting server equipment 24 is located in the “cloud”. Moreover, together the online meeting server equipment 24 and the user I/O devices 22 forms an online meeting system with sensory feedback.

The communications medium 26 is constructed and arranged to connect the various components of the computerized setting 20 together to enable these components to exchange electronic signals 40 (e.g., see the double arrow 40). At least a portion of the communications medium 26 is illustrated as a cloud to indicate that the communications medium 26 is capable of having a variety of different topologies including backbone, hub-and-spoke, loop, irregular, combinations thereof, and so on. Along these lines, the communications medium 26 may include copper-based data communications devices and cabling, fiber optic devices and cabling, wireless devices, combinations thereof, etc. Furthermore, the communications medium 26 is capable of supporting LAN-based communications, cellular communications, plain old telephone service (POTS) communications, combinations thereof, and so on.

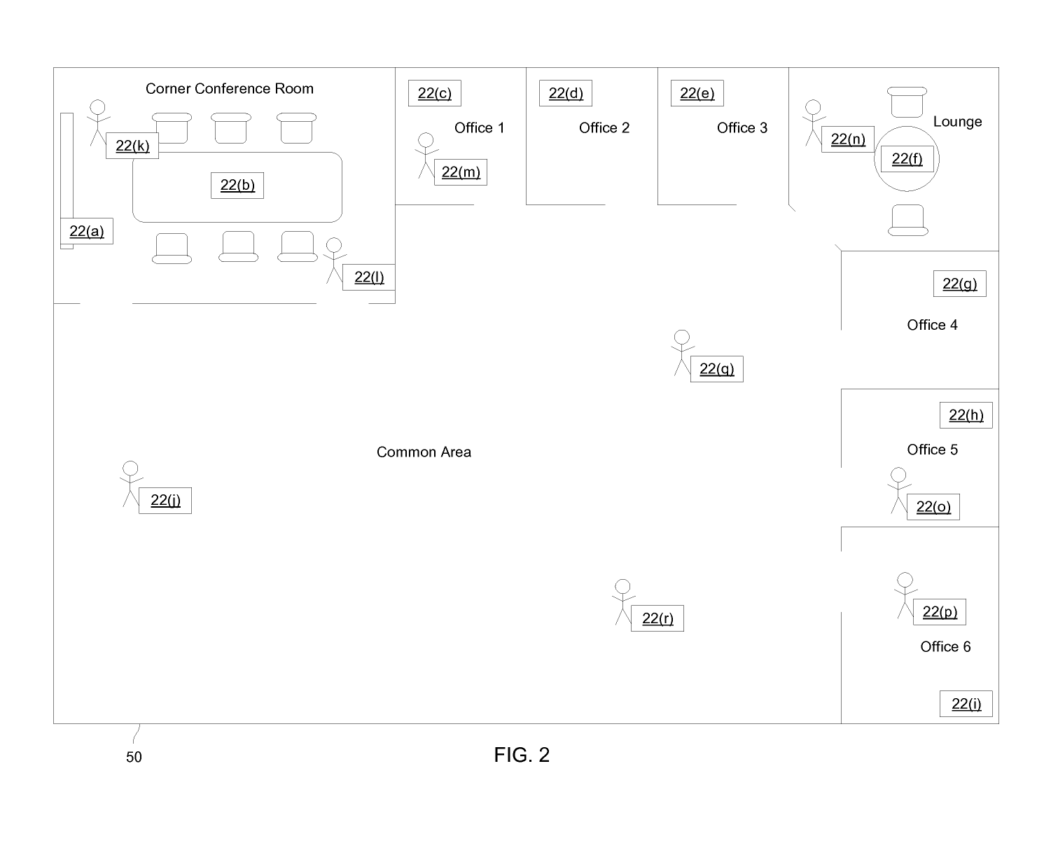

During operation and as will be explained in further detail shortly, the online meeting server equipment 24 collects configuration data 42 from the user I/O devices 22 during online meetings over time, and derives user behavior models 44 for the users 30 from the collected configuration data 42. Then, during future online meetings, the online meeting server equipment 24 uses the user behavior models 44 to activate and configure the user I/O devices 22 for the users 30 based on current situational factors such as each user's current location, time of day, which user I/O devices 22 are available, and so on. Further details will now be provided with reference to FIG. 2.

FIG. 2 shows an example layout 50 of an office area which includes multiple user I/O devices 22 available for use by users 30 during online meetings. Some user I/O devices 22 may be used by any user 30 (e.g., a smart television within a conference room, a workstation within a guest office, etc.). Other user I/O devices 22 are under control of a particular user 30 (e.g., a smart phone assigned to a particular user 30, a desktop computer in a particular user's office, etc.).

Some of the user I/O devices 22 are positioned at fixed locations within the layout 50. For example, in a conference room, the user I/O device 22(a) may be a wall-mounted smart television which is equipped with a microphone for audio input such as voice activation, a camera for video input, a keyboard and pointer apparatus for additional user input, and a large flat screen display. Within the same conference room, the user I/O device 22(b) may be computer terminal equipped with a webcam which is aimed at a marker board, and so on. Other user I/O devices 22(c), 22(d), . . . may be desktop computers assigned to particular users 30, and so on.

In contrast, certain user I/O devices 22 are able to change position within the layout 50. Along these lines, some user I/O devices 22(j), 22(k), 22(l), . . . are smart phones or other mobile apparatus (e.g., laptops, tablets, etc.) which can be carried by the users 30 among different locations. Such mobile user I/O devices 22 preferably include location identification circuitry (e.g., GPS circuits) to identify current locations of the user I/O devices 22.

It should be understood that in addition to running legacy online meeting applications, the user I/O devices 22 can be provisioned with specialized code to operate as augmented online meeting agents which convey configuration data to the online meeting server equipment 24, as well as respond to commands, event messages, etc. from the online meeting server equipment 24. Such specialized code, when executed by processing circuitry of the user I/O devices 22, forms specialized control circuitry which enables the user I/O devices 22 to perform enhanced operations to provide data as well as respond to the online meeting server equipment 24.

Over time, the online meeting server equipment 24 (FIG. 1) gathers configuration data 42, which may include pre-recorded (historical) operational data and settings, from the various user I/O devices 22 in order to construct a geographical awareness of the layout 50 and the user I/O devices 22 which are available within the layout 50. In particular, the online meeting server equipment 24 is able to classify particular user I/O devices 22 as geographically static (or fixed) and other user I/O devices 22 as geographically variable (or dynamic). Additionally, the online meeting server equipment 24 determines which user I/O devices 22 are shareable among multiple users 30, and which are used exclusively by a single user 30.

In some arrangements, the configuration data 42 is augmented by a thorough device registration process in which an administrator enters device information into the online meeting server equipment 24. In some arrangements, the configuration data 42 is further augmented via pre-populated database which includes a topology of a company's campus, buildings, offices, conference rooms, and so on. The combination of these and perhaps other data sources as well as learning from the gathered online meeting histories provides a rich and robust input to the online meeting server equipment 24 to enable user I/O device location awareness.

Additionally, over time, the online meeting server equipment 24 generates and updates user behavior models 44 for each user 40. That is, via predictive analytics, the online meeting server equipment 24 creates an electronic understanding of the user I/O devices 22 that each user 30 prefers to use when participating in online meetings within the layout 50. In particular, for each user 30, the online meeting server equipment 24 computes the frequency of use of each user I/O device 22 which is available to that user 30 when the user 30 is in particular locations within the layout 50. Accordingly, the online meeting server equipment 24 is able to operate as a behavioral engine to automatically activate and configure the user I/O devices 22 which are most popular or best suited to each user 30.

For instance, one user 30 may routinely connect the smart television (see the user I/O device 22(a) in FIG. 2) whenever that user 30 participates in an online meeting from the corner conference room. Accordingly, the online meeting server equipment 24 updates a user behavior model 44 so that when that user 30 participates in an online meeting from the corner conference room in the future, the online meeting server equipment 24 automatically activates the smart television and joins that smart television to the online meeting.

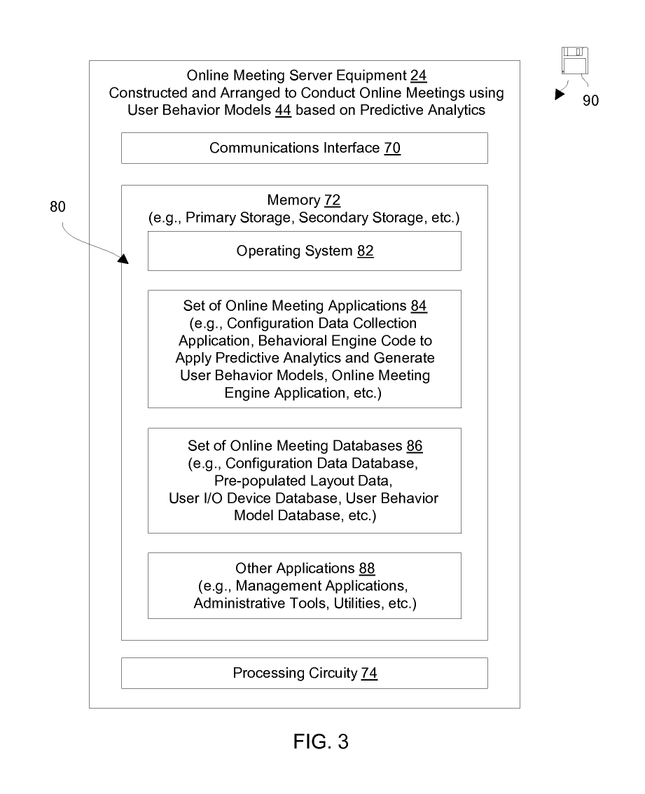

Alternatively, a different user 30 may disconnect the smart television whenever that user 30 participates in an online meeting from the corner conference room because the different user 30 prefers to run his/her laptop in tandem with a projector. Accordingly, the online meeting server equipment 24 updates a user behavior model 44 so that when that different user 30 participates in an online meeting from the corner conference room in the future, the online meeting server equipment 24 automatically deactivates the smart television and joins the laptop of the different user 30 to the online meeting. Further details will now be provided with reference to FIG. 3.

FIG. 3 is a block diagram of the online meeting server equipment 24 which conducts online meetings using user behavior models 44 based on predictive analytics. The online meeting server equipment 24 includes a communications interface 70, memory 72, and processing circuitry 74. Suitable form factors for the online meeting server equipment 24 include a mainframe, a set of blade servers, a server farm, a hardware platform providing a virtual environment and running virtual machines, distributed hardware devices, the cloud, combinations thereof, and so on.

The communications interface 70 is constructed and arranged to connect the online meeting server equipment 24 to the communications medium 26 (FIG. 1). Accordingly, the communications interface 70 enables the online meeting server equipment 24 to communicate with the other components of the computerized setting 20. Such communications may be line-based or wireless (i.e., IP-based, cellular, combinations thereof, and so on).

The memory 72 is intended to represent both volatile storage (e.g., DRAM, SRAM, etc.) and non-volatile storage (e.g., flash memory, magnetic disk drives, etc.). The memory 72 stores a variety of software constructs 80 including an operating system 82, a set of specialized online meeting applications 84, a set of online meeting databases 86, and other applications 88.

The processing circuitry 74 is constructed and arranged to operate in accordance with the various software constructs 80 stored in the memory 72. In particular, the processing circuitry 74, when executing the operating system 82, manages various resources of the online meeting server equipment 24 (e.g., memory allocation, processor cycles, etc.). Additionally, the processing circuitry 74 operating in accordance with the set of online meeting applications 84 forms specialized control circuitry to perform the particular operations of an online meeting server including collecting configuration data 42 from the user I/O devices 22, generating the user behavior models 44, and hosting online meetings (e.g., a configuration data collection engine to collect the configuration data 42, a behavioral engine to form and access the user behavior models 44, an online meeting engine to host the online meetings among the users 30, etc.). The configuration data 42 which is collected and used to conduct the online meetings is stored by the processing circuitry 74 in the set of online meeting databases 86. Furthermore, the processing circuitry 74, when operating in accordance with the other applications 88, enables performance of other activities such as administrative tasks, user enrollment, and so on.

It should be understood that the above-mentioned processing circuitry 74 may be implemented in a variety of ways including via one or more processors (or cores) running specialized software, application specific ICs (ASICs), field programmable gate arrays (FPGAs) and associated programs, discrete components, analog circuits, other hardware circuitry, combinations thereof, and so on. In the context of one or more processors executing software, a computer program product 90 is capable of delivering all or portions of the software to the online meeting server equipment 24. The computer program product 90 has a non-transitory and non-volatile computer readable medium which stores a set of instructions to control one or more operations of the online meeting server equipment 24. Examples of suitable computer readable storage media include tangible articles of manufacture and apparatus which store instructions in a non-volatile manner such as CD-ROM, flash memory, disk memory, tape memory, and the like.

During operation, a configuration data collection engine of the online meeting server equipment 24 collects configuration data 42 from the various user I/O devices 22 that are available to the users 30 participating in the online meetings. Such collection of configuration data 42 enables the online meeting server equipment 24 to perform, as part of the predictive analytics, trend identification to identify particular preferences for each user 30 such which user I/O devices 22 each user 30 prefers using at each location (e.g., the corner conference room, the lounge, Office 1, Office 2, . . . ). Additionally, the online meeting server equipment 24 gathers particular setting information from the user I/O devices 22 (e.g., volume settings, brightness settings, camera directional settings, etc.) so that the user 30 can start a future online meeting using the same custom settings as those from a previous online meeting.

In some situations, the online meeting server equipment 24 is able to obtain manufacturer information (e.g., a model number, a version number, etc.) to determine particular device features which are available and compare those device features with the device features of other available user I/O devices 22 at the same location. If there is a different user I/O device 22 with better device features (e.g., higher resolution, better signal-to-noise characteristics, etc.), the online meeting server equipment 24 is capable of suggesting to the user 30 to switch to the better user I/O device 22 at the next online meeting.

From the collected configuration data (i.e., preferred user I/O devices 22, custom settings, location input, etc.), a behavioral engine of the online meeting server equipment 24 generates a respective user behavior model 44 for each user 30. Each user behavior model 44 defines particular user I/O devices 22, their settings, and operating parameters, etc.

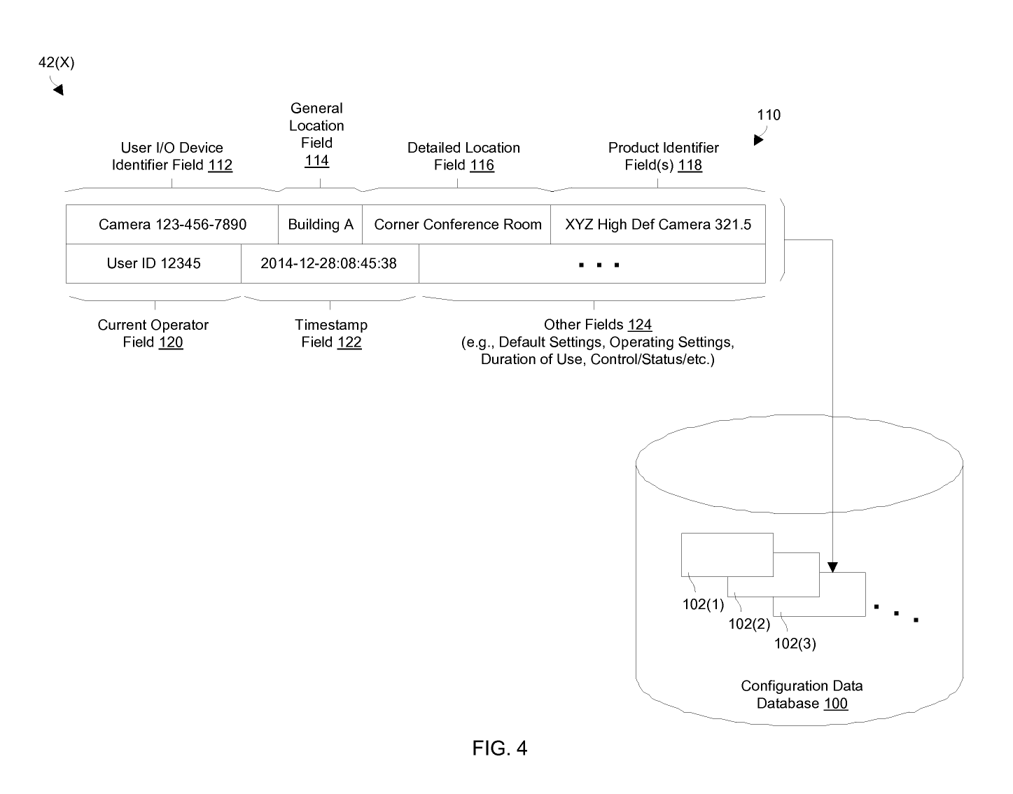

Then, when a user 30 joins a new online meeting, an online meeting engine of the online meeting server equipment 24 customizes available user I/O devices 22 based on the user behavior model 44 for that user 30. In particular, the online meeting engine communicates with the behavior engine to refer to the user behavior model 44 for that user 30 and, based on the user's current location, automatically activates and configures the available user I/O devices 22 on behalf of the user 30 to convey user I/O between that user 30 and other users 30 participating in the current online meeting. Accordingly, the user 30 is able to enjoy a custom/optimized online meeting environment without extensive configuration time and effort. Further details will now be provided with reference to FIG. 4.

FIG. 4 shows example configuration data 42(X) which is supplied by a user I/O device 22 to a configuration data database 100 which is managed by the configuration data engine of the online meeting server equipment 24. As shown in FIG. 4, the configuration data database 100 includes entries 102(1), 102(2), 102(3), . . . (collectively, entries 102) containing configuration data 42 from the user I/O devices 22.

By way of example only, the configuration data 42(X) includes a variety of fields 110 which contains specific data regarding a particular user I/O device 22 and usage. Such configuration data 42(X) is continuously gathered by the online meeting server equipment 24 over time (e.g., during online meetings).

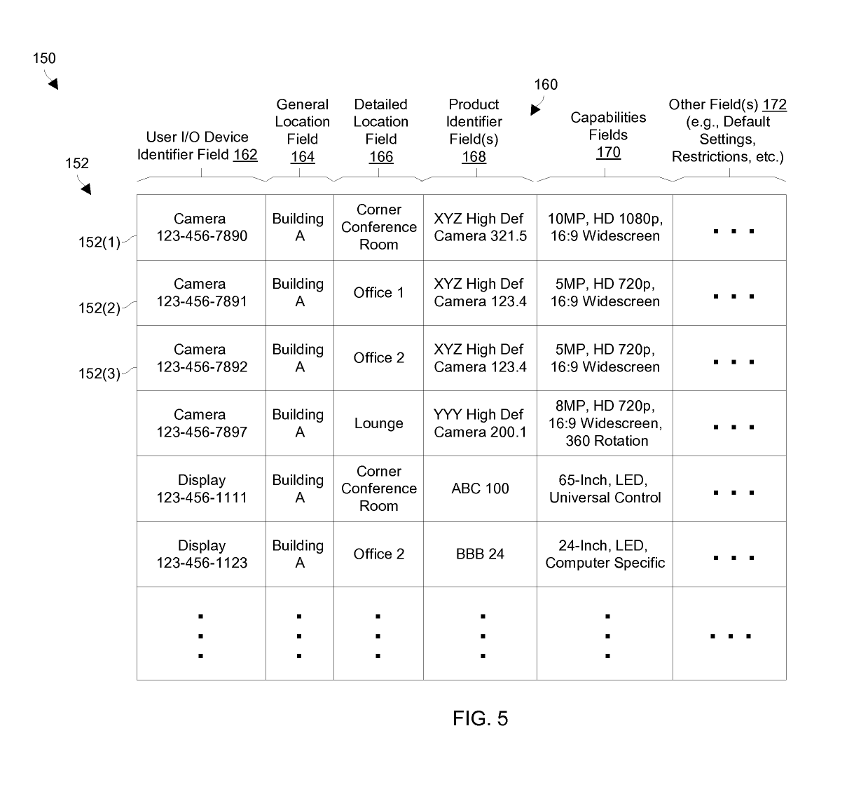

The configuration data 42(X) includes a user I/O device identifier field 112, a general location field 114, a detailed location field 116, a product identifier field 118, a current operator field 120, a timestamp field 122, and other fields 124. The user I/O device identifier field 112 holds a user I/O device identifier (or ID) which uniquely identifies a particular user I/O device 22 (e.g., a smart phone in possession of a particular user 30). The general location field 114 holds general location data describing a general location of the particular user I/O device 22 (e.g., Building A). The detailed location field 116 holds detailed location data describing a detailed or specific location of the particular user I/O device 22 (e.g., the corner conference room in the layout 50 of FIG. 3). The product identifier field (or fields) 118 holds product identifying data which precisely identifies the particular type of user I/O device 22 (e.g., the manufacturer, the model number, a serial number, software versions, etc.). The current operator field 120 holds a user identifier which uniquely identifies the user 30 among other users 30. The timestamp field 122 holds a timestamp which identifies the current time (i.e., time of use). The other fields 124 contain other information to such as default settings, custom operating settings, duration of use, control/status, and so on. Accordingly, the configuration data database 100 amasses histories of user I/O device usage during online meetings to support trend/usage analysis (e.g., big data analytics). Further details will now be provided with reference to FIG. 5.

FIG. 5 shows example pre-populated user I/O device data 150 which is supplied by an administrator to the configuration engine of the online meeting server equipment 24 for entrance into the configuration data database 100 (FIG. 4). The pre-populated user I/O device data 150 includes individual entries 152(1), 152(2), 152(3), . . . (collectively, entries 152) which describes respective user I/O devices 22 for a particular area, location, building, organization, etc. (e.g., see the layout 50 in FIG. 3).

By way of example only, the pre-populated user I/O device data 150 includes a variety of fields 160 similar to that of the configuration data 42(X). Such data 150 can be input by the administrator via a dialogue window, a file, a separate database, and so on thus enabling the administrator to input information regarding user I/O devices 22 en masse.

Each entry 152 of the pre-populated user I/O device data 150 includes a user I/O device identifier field 162, a general location field 164, a detailed location field 166, a product identifier field 168, capabilities fields 170, and other fields 172. The user I/O device identifier field 162 of each entry 152 holds a user I/O device identifier (or ID) which uniquely identifies a particular user I/O device 22 (e.g., a camera, a display, a microphone, a speaker, a smart television, an online conferencing assembly, etc.). The general location field 164 holds general location data describing a general location of the particular user I/O device 22 (e.g., Building A). The detailed location field 166 holds detailed location data describing a particular location of the particular user I/O device 22 (e.g., the corner conference room in the layout 50 of FIG. 3). The product identifier field (or fields) 168 holds product identifying data which precisely identifies the particular type of user I/O device 22 (e.g., the manufacturer, the model number, a serial number, software versions, etc.). The capabilities fields 170 hold capability information regarding the user I/O device 22 (e.g., resolution, screen size, signal-to-noise ratio, etc.). The other fields 172 contain other information to such as default settings, restrictions, and so on. Accordingly, the pre-populated user I/O device data 150 enables the administrator to incorporate awareness of user I/O devices 22 on a large scale.

It should be understood that, in some arrangements, the online meeting server equipment 24 determines whether there is missing information in the pre-populated user I/O device data 150 (e.g., missing capabilities information), and provides a vehicle for obtaining the missing information. For example, the online meeting server equipment 24 may prompt an administrator to input the missing information. As another example, the online meeting server equipment 24 searches the Internet such as the manufacturer's product database to obtain the missing information, and so on.

In some arrangements, the pre-populated user I/O device data 150 serves as a server directory database that contains pre-populated information about an enterprise's buildings, offices, meeting rooms, etc., along with user information. Such a directory database is capable of being accessible by the behavioral engine of the online meeting server equipment 24 to query users 30, office and company data and associated them with captured events.

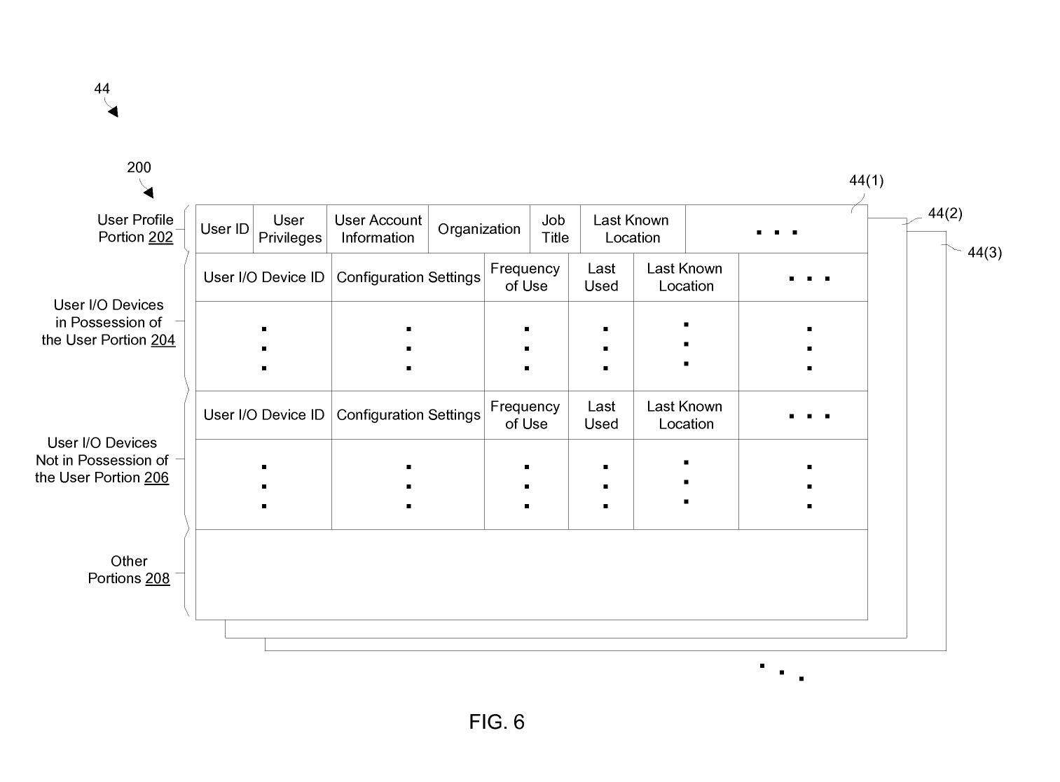

Additionally, in some arrangements, the online meeting server equipment 24 manages separate databases for different types of user I/O devices 22. Along these lines, the online meeting server equipment 24 maintains a microphone database to store data regarding available microphones used by the users 30 during online meetings, a camera database to store data regarding available cameras used by the users 30 during online meetings, a display database to store data regarding available displays used by the users 30 during online meetings, a speaker database to store data regarding available speakers used by the users 30 during online meetings, and so on. Further details will now be provided with reference to FIG. 6.

FIG. 6 shows an example set of user behavior models 44(1), 44(2), 44(3), . . . (collectively, user behavior models 44) which are generated and utilized by the online meeting server equipment 24 for the users 30 to conduct online meetings. That is, a user behavior model 44(1) supports online meetings for a first user, a user behavior model 44(2) supports online meetings for a second user, a user behavior model 44(3) supports online meetings for a third user, and so on.

As mentioned earlier, the behavior engine of the online meeting server equipment 24 creates these models 44 and periodically updates them by applying predictive analytics to the configuration data 42 in the configuration database 100 (also see FIGS. 4 and 5) so that the models 44 accurately reflect user preferences for future online meetings. It should be understood that the set of user behavior models 44 are illustrated as two dimensional arrays of data even though other formats are suitable for use (e.g., relational databases, linked lists, complex data structures, etc.).

As shown in FIG. 6, each user behavior model 44 includes multiple portions 200. Namely, each user behavior model 44 includes a user profile portion 202, a user I/O devices in possession of the user portion 204, a user I/O devices not in possession of the user portion 206, and other portions 208.

The user profile portion 202 of each user behavior model 44 includes specific information regarding a particular user 30 such as a user identifier (or user ID) which uniquely identifies the particular user 30, user privileges (e.g., special abilities, access privileges, etc.), user account information (e.g., how long the user has used the online meeting system, address, phone number, email address, online meeting information, etc.), the organization of the user (e.g., company, service, etc.), job title, the user's current location or last known location, as well as other information. In some arrangements, the user's 30 enter online meeting preferences into the online meeting system (e.g., use display with the best resolution, use the largest display, use the highest quality microphone, use the user's desktop computer if available, etc.) thus enabling the online meeting server equipment 24 to better customize selection and configuration of the user I/O device 22 for future online meetings.

The user I/O devices in possession of the user portion 204 holds a list of preferred user I/O devices 22 which are in possession of the particular user 30. This list may include the user's smart phone, the user's tablet, the user's laptop computer, the user's desktop computer, and so on. Based on an evaluation of the configuration data database 100, the online meeting server equipment 24 stores the user's previous configuration settings which may be different that the devices' default settings, as well as tabulates the frequency of use of each user I/O device 22 on the list (i.e., which devices 22 the user tends to use) to determine the user's preferred I/O devices 22.

The user I/O devices not in possession of the user portion 206 holds a list of preferred user I/O devices 22 which are not in possession of the particular user 30. This list may include shared user I/O devices 22 which the particular user 30 has used in the past, previous configuration settings, and so on. Based on an evaluation of the configuration data database 100, the online meeting server equipment 24 stores those previous configuration settings which may be different that the devices' default settings, as well as tabulates the frequency of use of each user I/O device 22 on the list (i.e., which devices 22 the user tends to use) again to determine the user's preferred devices 22.

Accordingly, based on the user behavior model 44, the online meeting server equipment 24 now stores an awareness of which user I/O devices 22 are preferred by each user 30. Thus, if a particular user 30 is in a room for an online meeting with multiple user I/O devices 22 available (e.g., the user's smart phone, the user's desktop computer, the user's smart television, etc.), the online meeting server equipment 24 is able to automatically select and configure the most preferred devices 22 based on the user's historical use of the devices 22 thus saving user time and effort. Moreover, if there are newly discovered user I/O devices 22 which are superior to the existing user I/O devices 22 listed on the user behavior model 44 (e.g., a new smart television, a new online meeting conferencing apparatus, etc.), the online meeting server equipment 24 can be configured to suggest or offer those newly discovered devices 22 to the user 30 for future online meetings.

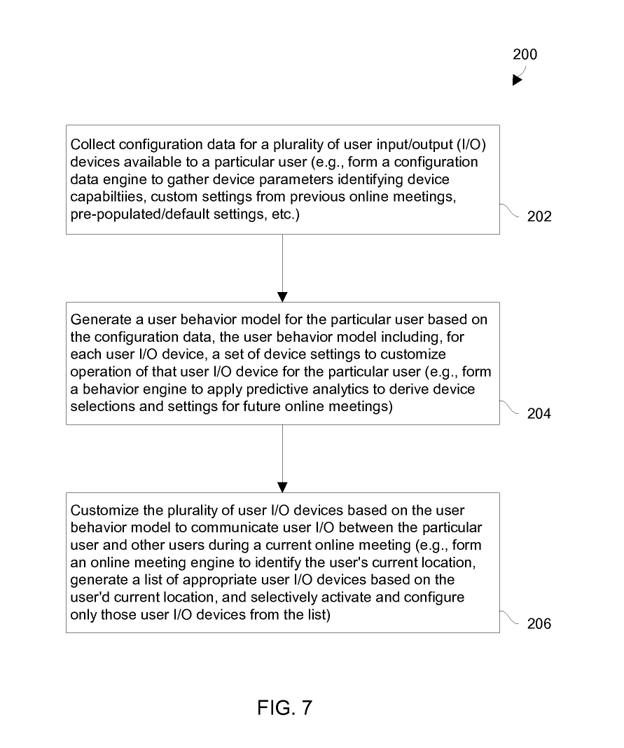

The other portion 208 is capable of storing additional user behavior data for the particular user 30. Along these lines, the other portion 208 can store a general set of rules or settings for new user I/O devices 22 (e.g., settings to lower volume levels in general because the user 30 prefers softer volume, settings to increase brightness or contrast because the user 30 tends to struggle viewing electronic displays, etc.). Moreover, the other portion 208 can include corroborating data between user I/O devices 22 (e.g., data from a camera which operates as a light sensor for use in controlling brightness of an electronic display even through the two user I/O devices 22 are independent of each other). Further details will now be provided with reference to FIG. 7.

FIG. 7 is a flowchart of a procedure 200 which is performed by the online meeting server equipment 24. It should be understood that the procedure 200 is performed continuously and for each user 30 of the computerized setting 20.

At 202, the online meeting server equipment 24 collects configuration data 42 for a plurality of user input/output (I/O) devices 22 available to a particular user 30. Along these lines, a configuration data engine of the online meeting server equipment 24 gathers device parameters which identify individual capabilities of each user I/O device 22 (e.g., display resolution, microphone signal-to-noise ratios, etc.), custom settings made by the particular user 30 during previous online meetings (e.g., volume settings, camera direction settings, display brightness settings, etc.), and pre-populated default settings defining default operation of the user I/O devices 22 during a default online meeting (i.e., standard/nominal use settings, administrator input, etc.).

At 204, a behavior engine of the online meeting server equipment 24 generates a user behavior model 44 for the particular user 30 based on the configuration data 42. The user behavior model 44 includes, for each user I/O device 22, a set of device settings to customize operation of that user I/O device 22 for the particular user 30. Here, the online meeting server equipment 24 applies predictive analytics to derive, for each available user I/O device 22, device settings to customize operation of the user I/O devices 22 during future online meetings. Such big data analytics involves identifying preferred user I/O devices 22 for the particular user 30 at various locations, e.g., when the user 30 is in his/her office, when the user 30 is in the corner conference room, etc. (also see FIG. 2). Such identification is based on which user I/O devices 22 the user 30 has used during past online meetings and the frequency of such use (e.g., which user I/O device 22 was used last, which user I/O devices 22 was used most often, etc.). Moreover, the online meeting server equipment 24 acquires any custom user settings that the user 30 made to the user I/O devices 22, and saves those setting for automatic configuration of the user I/O devices 22 during future online meetings by the user 30.

At 206, an online meeting engine of the online meeting server equipment 24 customizes the plurality of user I/O devices 22 based on the user behavior model 44 to communicate user I/O between the particular user 30 and other users 30 during a current online meeting. Here, the online meeting server equipment 24 queries the GPS circuitry of the user's smart phone (which is also a user I/O device 22) for a location signal which the online meeting server equipment 24 uses to identify the user's current location. Then, based on the user's current location, the online meeting server equipment 24 generates a list of appropriate user I/O devices 22 based on the user behavior model 44 and the user's current location.

Next, the online meeting server equipment 24 activates only the appropriate user I/O devices 22 on the list to join the user 30 to the current online meeting. During such activation, the online meeting server equipment 24 customizes the operation of the user I/O devices 22 (e.g., uses the user's previous volume settings, brightness settings, camera angle, etc.) thus alleviating the need for the user 30 to manually configure the devices 22 for the online meeting.

It should be understood that the online meeting server equipment 24 performs the procedure 200 for each user 30 of the online meeting system. As a result, the online meeting server equipment 24 able to robustly build stateful historical recordings of user actions, activities, settings, configurations as the users 30 engage in online meetings from different locations using different devices 22 collaborating with different people. In particular, the online meeting server equipment 24 applies various forms of computer analytics to predict user behaviors and automatically adjust settings, configurations, etc. of the various user I/O devices 22 which are available to those online meetings.

As described above, improved techniques involve conducting online meetings utilizing user behavior models 44 which automatically direct usage of particular user I/O devices 22 during the online meetings. In particular, as users 30 engage in initial online meetings with colleagues, peers, friends, etc., online meeting circuitry collects histories of which user I/O devices 22 are available and used by each user 30. Predictive analytics is then applied to derive user behavior models 44 which control activation and configuration of those user I/O devices 22 during future online meetings. Accordingly, the users 30 are less burdened with manual details of selecting and configuring user I/O devices 22 for online meetings over time.

One should appreciate that the above-described techniques are not merely applying big data analytics to online meeting data. Rather, the disclosed techniques involve collection of particular configuration data 42 regarding user I/O devices 22 (e.g., cameras, microphones, displays, speakers, etc.) and generating user behavior models 44 based on that configuration data 42. Such user behavior models 44 particularly identify preferred user I/O devices 22 and custom settings (e.g., based on past use, based on device capabilities, etc.). Then, such user behavior models 44 are used to automatically activate and configure the preferred user I/O devices 22 in future online meetings for the user 30. Accordingly, the disclosed techniques enable utilization of adaptive behavioral models for human digital collaboration.

While various embodiments of the present disclosure have been particularly shown and described, it will be understood by those skilled in the art that various changes in form and details may be made therein without departing from the spirit and scope of the present disclosure as defined by the appended claims.

For example, it should be understood that various components of the online meeting server equipment 24 are capable of being implemented in or “moved to” the cloud, i.e., to remote computer resources distributed over a network. Here, the various computer resources may be distributed tightly (e.g., a server farm in a single facility) or over relatively large distances (e.g., over a campus, in different cities, coast to coast, etc.). In these situations, the network connecting the resources is capable of having a variety of different topologies including backbone, hub-and-spoke, loop, irregular, combinations thereof, and so on. Additionally, the network may include copper-based data communications devices and cabling, fiber optic devices and cabling, wireless devices, combinations thereof, etc. Furthermore, the network is capable of supporting LAN-based communications, SAN-based communications, combinations thereof, and so on.

Additionally, it should be understood that online meeting users 30 may conduct online meetings on a daily basis. Each time the users 30 use the online meeting system, the users 30 interact with colleague, peers, friends, etc., the users 30 employ the user I/O devices 22 that they carry personally or that are available in their current locations. With the improvements disclosed herein, various models are established for users 30 as they engage in those online meetings based on their history of past engagement via application of predictive analytics to improve the ease, quality, and experience of their future collaboration sessions.

One should appreciate that the disclosed techniques enable establishment of analytical models that includes actors (people), computing devices, communication peripherals, etc. In particular, online meeting interaction of users 30 is monitored to enable the online meeting system to automatically learn and control the user I/O devices 22 to make future online meetings easier, simpler and faster.

In one example, the online meeting system adjusts camera settings based on a participant's user location. In particular, such adjustment can be based on the direction of light coming from room window (e.g., as identified by a camera in the vicinity, weather, time of day, combinations thereof, etc.) and where user's computer and chair resides. Once the system captures this knowledge, the system is able to configure the camera settings in a similar manner (but perhaps with adjustments due to current conditions) during future online meetings.

As another example, the online meeting system is capable of adjusting a user's microphone volume automatically. Such adjustment is capable of depending on the kind of microphone that is used, its location in the room, distance from the user, and so on.

As yet another example, the online meeting system is able to automatically adjust screen brightness of the user's display, connect the user to the right input device (keyboard), and so on. Such operation alleviates the burden of the user having to manually make such adjustments.

One should further appreciate that an online meeting client device agent program can be installed on every monitored device 22 where the meeting experience is delivered and presented (also see the user I/O devices 22 in FIG. 1). The agent can contain the following code:
(i) a meeting collaboration code to enable the users 30 to participate in online meetings (e.g., an online meeting application).
(ii) configuration data collection code to monitor, capture and control access to video, audio and display output along with camera input (e.g., drivers, kernel access routines, etc. to interface with the devices' operating systems, etc.).
(iii) stateful behavioral engine code to form a stateful behavioral engine that interacts with the components listed above to monitor and respond to event notifications which are generated locally within the devices 22 as well as from the online meeting equipment 24. The stateful behavioral engine is then able to respond via controlling structured commands. The stateful behavioral engine maintains a device local database that secured via encryption and unauthorized access to its content is prevented via a file system control agent (e.g., a file system filter driver or a standard facility provided by the operating system). The local database is periodically uploaded to the online meeting equipment 24 (e.g., cloud backend infrastructure and stored with the online meeting equipment databases (e.g., see FIGS. 4 and 5).
(iv) user configuration agent code to form a user configuration agent which interacts with the user and captures user settings and configuration. The user configuration agent interacts with the behavioral stateful engine sending user's configuration and receive back controlling commands.
(v) communications agent code to form a communications agent to connect the stateful behavioral engine with the online meeting equipment 24. Enterprise administrators can configure and administer the collaboration experience via the online meeting equipment 24 (e.g., a cloud-based software as a service).

One will further appreciate that end users 30 are able to interact with the above-listed collaboration code running on their devices 22 and thus provide their own settings and configuration. System administrators will interact with the management server of the online meeting equipment 24. During such operation, the device behavioral engine of the online meeting equipment 24 captures all settings, configurations and policies as set by both meetings participates (users 30) and system administrators. Those configuration and settings are stored in the behavioral database and stamped with the proper meta-information: time, device-ID, user-ID, office location, room location, company info, user department info, etc. (also see FIGS. 4 through 6).

In some arrangements, the behavioral engine of the online meeting equipment 24 acquires user locations, contacts, calendar data (e.g., event information), to-do lists, etc. and derives rules out of the content stored in them. Accordingly, the online meeting equipment 24 can automatically remind users 30 of upcoming online meetings, join users 30 to online meetings, and so on.

It should be understood that the disclosed improvements are useful in the case of distributed meeting sessions in which users 30 use multiple apparatus, multiple I/O peripherals, etc. The improvements provides for additional levels of access control heuristics based on each user's historical contributions in online meetings, e.g., which user 30 gets access to which I/O peripherals that is available to more than one user. Suitable online meeting resources which can be allocated in this manner include WiFi, Web-based cameras, and so on.

In some arrangements, the online meeting system automatically turns on, activates and configures the user I/O devices 22 that the user 30 would otherwise need to manually turn on depending on the user's location, a list of accessible devices, etc. Such operation greatly improves the user's experience during online meetings.

Moreover, the online meeting system is configurable based on user choice, allowing users 30 to define new objects and how the interaction with them should be. Along these lines, the online meeting system has awareness of location and allows the user to define his home, office, library, school, etc. locations along with policies associated with each. Furthermore, the online meeting system can maintain a list of known participant and how configuration should operate by default. For instance, a user 30 can define a rule in which certain camera will be turned ON, if user is in certain location and collaborating with certain other user 30.

In some arrangements, the online meeting system alerts a user 30, in case his/her settings are different from those predictions established by the system. Such operation enables the user 30 maintain current settings or modify (e.g., upgrade, improve, etc.) operation of the user I/O devices 22 in future online meetings.

Additionally, in connection with the cloud side of the service, the online meeting system can collect individual user's behavioral insights and share such insights across users 30 (e.g., peers, colleagues, etc.) as the users 30 engage together in collaboration sessions. Furthermore, the online meeting system allows users 30 to share their behavioral insights with others, which can be a very valuable feature especially considering situations when users 30 use the same meeting rooms, devices and I/O peripherals. Such modifications and enhancements are intended to belong to various embodiments of the disclosure.

What is claimed is:

1. A computer-implemented method of conducting an online meeting, the computer-implemented method comprising:
collecting, by processing circuitry, configuration data for a plurality of user input/output (I/O) devices available to a particular user;
generating, by the processing circuitry, a user behavior model for the particular user based on the configuration data, the user behavior model including, for each user I/O device of the plurality of user I/O devices, a set of device settings to customize operation of that user I/O device for the particular user; and
customizing, by the processing circuitry, the plurality of user I/O devices based on the user behavior model to communicate user I/O between the particular user and other users during a current online meeting.

2. A computer-implemented method as in claim 1 wherein collecting the configuration data for the plurality of user I/O devices includes:
gathering device parameters from the plurality of user I/O devices, the device parameters identifying individual capabilities of each user I/O device of the plurality of user I/O devices.

3. A computer-implemented method as in claim 1 wherein collecting the configuration data for the plurality of user I/O devices includes:
obtaining initial settings from the plurality of user I/O devices, the initial settings customizing operation of the plurality of user I/O devices during an initial online meeting of the particular user which occurs prior to the current online meeting.

4. A computer-implemented method as in claim 1 wherein collecting the configuration data for the plurality of user I/O devices includes:
acquiring pre-populated default settings for the plurality of user I/O devices, the pre-populated default settings defining default operation of the plurality of user I/O devices during a default online meeting.

5. A computer-implemented method as in claim 1 wherein collecting the configuration data for the plurality of user I/O devices includes:
gathering device parameters from the plurality of user I/O devices, the device parameters identifying individual capabilities of each user I/O device of the plurality of user I/O devices,
obtaining initial settings from the plurality of user I/O devices, the initial settings customizing operation of the plurality of user I/O devices during an initial online meeting of the particular user which occurs prior to the current online meeting, and
acquiring pre-populated default settings for the plurality of user I/O devices, the pre-populated default settings defining default operation of the plurality of user I/O devices during a default online meeting;
wherein the device parameters, the initial settings, and the pre-populated default settings form part of the configuration data; and
wherein generating the user behavior model includes:
deriving, for each user I/O device of the plurality of user I/O devices, device settings to customize operation of that user I/O device based on analytics performed on the configuration data.

6. A computer-implemented method as in claim 5 wherein customizing the plurality of user I/O devices based on the user behavior model includes:
receiving a location signal from the particular user, the location signal identifying a current location of the particular user,
generating a list of appropriate user I/O devices based on the user behavior model and the current location of the particular user identified by the location signal, the list of appropriate user I/O devices identifying less than all of the plurality of user I/O devices, and
activating only the appropriate user I/O devices on the list of appropriate user I/O devices to include only the appropriate user I/O devices and less than all of the plurality of user I/O devices in the current online meeting.

7. A computer-implemented method as in claim 6 wherein activating only the appropriate I/O user devices includes:
replacing at least some default settings of the appropriate user I/O devices with the derived device settings to customize operation of the appropriate user I/O devices.

8. A computer-implemented method as in claim 6 wherein activating only the appropriate I/O user devices includes:
during the current online meeting, activating a particular microphone among multiple available microphones, and adjusting a volume setting of the particular microphone,
during the current online meeting, activating a particular camera among multiple available cameras, and adjusting a direction setting of the particular camera,
during the current online meeting, activating a particular speaker among multiple available speakers, and adjusting a volume setting of the particular speaker, and
during the current online meeting, activating a particular display among multiple available displays, and adjusting a brightness setting of the particular display.

9. A computer-implemented method as in claim 8 wherein at least two of the particular microphone, the particular camera, the particular speaker and the particular display reside on a single user apparatus.

10. A computer-implemented method as in claim 8 wherein one of the particular microphone, the particular camera, the particular speaker and the particular display resides on first user apparatus; and
wherein another of the particular microphone, the particular camera, the particular speaker and the particular display resides on second user apparatus which is different than the first user apparatus, the second user apparatus operating independently of the first user apparatus.

11. A computer-implemented method as in claim 10 wherein the first user apparatus is a mobile apparatus.

12. A computer-implemented method as in claim 10 wherein the second user apparatus is a stationary apparatus.

13. A computer-implemented method as in claim 6 wherein the plurality of user I/O devices includes multiple microphones;
wherein the configuration data defines a numerical sound quality measurement and a location for each microphone of the multiple microphones;
wherein the user behavior model includes a microphone database which identifies preferred microphones for different locations based on the numerical sound quality measurement and the location for each microphone defined by the configuration data; and
wherein activating only the appropriate I/O user devices includes, in response to accessing the microphone database of the user behavior model, activating exactly one of the preferred microphones during the current online meeting.

14. A computer-implemented method as in claim 6 wherein the plurality of user I/O devices includes multiple cameras;
wherein the configuration data defines a resolution and a location for each camera of the multiple cameras;
wherein the user behavior model includes a camera database which identifies preferred cameras for different locations based on the resolution and the location for each camera defined by the configuration data; and
wherein activating only the appropriate I/O user devices includes, in response to accessing the camera database of the user behavior model, activating exactly one of the preferred cameras during the current online meeting.

15. A computer-implemented method as in claim 6 wherein the plurality of user I/O devices includes multiple speakers;
wherein the configuration data defines a resolution and a location for each speaker of the multiple speakers;
wherein the user behavior model includes a speaker database which identifies preferred speakers for different locations based on the resolution and the location for each speaker defined by the configuration data; and
wherein activating only the appropriate I/O user devices includes, in response to accessing the speaker database of the user behavior model, activating exactly one of the preferred speakers during the current online meeting.

16. A computer-implemented method as in claim 6 wherein the plurality of user I/O devices includes multiple displays;
wherein the configuration data defines a numerical display quality measurement and a location for each display of the multiple displays;
wherein the user behavior model includes a display database which identifies preferred displays for different locations based on the numerical display quality measurement and the location for each display defined by the configuration data; and
wherein activating only the appropriate I/O user devices includes, in response to accessing the display database of the user behavior model, activating exactly one of the preferred displays during the current online meeting.

17. A computer-implemented method as in claim 1, further comprising:
generating, by the processing circuitry, other user behavior models for the other users, and
customizing the plurality of user I/O devices based on the other user behavior model to communicate user I/O among all of the users during the current online meeting.

18. A computer-implemented method as in claim 17, further comprising:
acquiring new configuration data from the plurality of user I/O devices during the current online meeting, and
updating the user behavior model for the particular user and the other user behavior models for the other users based on the new configuration data acquired from the plurality of user I/O devices during the current online meeting.

19. Online meeting server equipment, comprising:
a communications interface;
memory; and
control circuitry coupled to the communications interface and the memory, the memory storing instructions which, when carried out by the control circuitry, cause the control circuitry to:
collect, through the communications interface, configuration data for a plurality of user input/output (I/O) devices available to a particular user,
generate a user behavior model for the particular user based on the configuration data, the user behavior model including, for each user I/O device of the plurality of user I/O devices, a set of device settings to customize operation of that user I/O device for the particular user, and
customize, through the communications interface, the plurality of user I/O devices based on the user behavior model to communicate user I/O between the particular user and other users during a current online meeting.

20. A computer program product having a non-transitory computer readable medium which stores a set of instructions to conduct an online meeting, the set of instructions, when carried out by computerized circuitry, causing the computerized circuitry to perform a method of:
collecting configuration data for a plurality of user input/output (I/O) devices available to a particular user;
generating a user behavior model for the particular user based on the configuration data, the user behavior model including, for each user I/O device of the plurality of user I/O devices, a set of device settings to customize operation of that user I/O device for the particular user; and
customizing the plurality of user I/O devices based on the user behavior model to communicate user I/O between the particular user and other users during a current online meeting.
